(19) United States
(12) Patent Application Publication
(10) Pub. No.: US 2004/0150698 A1
(43) Pub. Date: Aug. 5, 2004

(54) Inkjet pen with removable lid

(76) Inventors: William Caro, Aguadilla, PR (US); Ivan Baiges, Mayaguez, PR (US); Miguel Acosta, Aguadilla, PR (US)

Correspondence Address: HEWLETT-PACKARD COMPANY, Intellectual Property Administration, P.O. Box 272400, Fort Collins, CO, 80527-2400, US

(21) Appl. No.: 10/356,776

(22) Filed: Jan. 31, 2003

(51) Int. Cl. B41J 2/175

(52) U.S. Cl. 347/86; 347/87

(57) ABSTRACT

Inkjet pen apparatus include a pen body, a print head supported on the body, and a removable lid configured to engage the body by one of several means. Methods of enclosing an inkjet pen reservoir include providing a body that defines an ink reservoir, providing a lid configured to removably engage the body by one of several means, and placing the lid in removable retainment with respect to the body. The body and lid can include one each of a number of lid-engagement features, and body-engagement features, respectively, that are configured to cause the lid to be removably retained on the body.

### BACKGROUND OF THE INVENTION

Inkjet printing mechanisms generally include “pens” that are configured to project, or “fire,” drops of liquid colorant, referred to generally herein as “ink,” onto a page of media. Each pen usually has a print head supported thereon. The print head is formed with very small nozzles through which the ink drops are fired. To print an image, the print head is generally propelled back and forth across the page, while firing ink drops.

The particular ink firing mechanism within the print head may have one of a variety of forms known to those skilled in the art, and which include those forms employing piezo-electric or thermal print head technology. For instance, two earlier thermal ink-firing mechanisms are shown in U.S. Pat. Nos. 5,278,584 and 4,683,481.

In a thermal type of ink firing mechanism, a barrier layer containing ink channels and vaporization chambers is located between a nozzle orifice plate and a substrate layer. The substrate layer typically contains linear arrays of heater elements, such as resistors, which are energized to heat ink within the vaporization chambers. Upon heating, an ink droplet is fired from a nozzle associated with the energized resistor. By selectively energizing the resistors as the print head moves across the page, the ink is projected onto the page to form a desired image (e.g. picture, chart, or text).

Conventional inkjet pens generally include a body, or tank, that defines a reservoir which is configured to contain a given volume of liquid ink. The print head, discussed above, is usually supported on the body of the pen and fluidly connected with the reservoir so that ink is supplied from the reservoir to the print head for firing onto a page of media.

The reservoir of the pen body generally contains one or more additional components, depending upon the specific type and/or configuration of the pen. For example, some conventional pens employ a piece of foam material within the reservoir to control the flow of ink. Other such components can include ink bladders, springs, ink filters, and various partitions and the like.

Prior art pen bodies are generally fabricated from a substantially rigid material such as injection-molded plastic or the like. The pen body typically has a substantially rectilinear shape and is initially formed so as to have one open side—usually the top side. Any components internal to the pen body are then assembled, and/or inserted, into the reservoir through the open side. A lid, or panel, is then permanently attached to the body to close the open side.

The lid is generally of the same material as the remainder of the body and is usually attached by ultrasonic welding, heat staking, or the like. Thus, during manufacture, the reservoir of the pen body is permanently sealed along with any internal components such as foam, bladders, springs, filters, and the like. The ink can be placed within the reservoir either before the lid is attached, or after its attachment by way of one or more openings which can be defined through the pen body. Various examples of conventional prior art pen bodies with lids are disclosed in U.S. Pat. Nos. 6,074,049, 6,095,643, 6,238,042, and 6,247,803.

While the above-described inkjet pen configuration is known to function satisfactorily, several disadvantages can be associated therewith. For example, to facilitate the ultrasonic welding process (one of the most popular attachment means) for attachment of the lid, both the lid and the remainder of the body must generally be of a common or similar material and must also usually be of a relatively high-grade, and therefore relatively expensive, plastic.

Additionally, even with the use of relatively high-grade materials, the ultrasonic welding process has been known to result in the formation of cracks in the body and/or the lid. The formation of such cracks during the ultrasonic welding process has been known to occur in a significant portion of welded pen bodies and/or lids. Pen bodies and/or lids that develop such cracks as the result of the ultrasonic welding process are generally unsalvageable and must be scrapped.

Moreover, in some cases, one or more of the components internal to the reservoir will fail or will be discovered as inoperable during the manufacturing process. Thus, it can be desirable in such cases to salvage any serviceable internal components remaining within the reservoir. However, because of the permanent nature of the bond between the lid and the pen body as the result of the ultrasonic welding process, the body and lid must generally be destroyed or be damaged beyond repair in order to remove the lid from the body, or to otherwise reopen the reservoir to gain access to the internal components.

### SUMMARY OF THE INVENTION

In accordance with one embodiment of the present invention, an inkjet pen includes a body, a print head operatively supported on the body, and a lid configured to removably engage the body. That is, the lid is not permanently attached or connected to the body. The body together with the removable lid, when engaged therewith, substantially encloses an ink reservoir in which liquid ink can be stored and fed therefrom to the print head. The removable nature of the lid can facilitate salvaging and/or recycling of components internal to the body.

### DESCRIPTION OF THE DRAWINGS

FIG. 1 is an isometric view in which an inkjet pen is depicted in accordance with one embodiment of the invention.

FIG. 2 is a partial side elevation cutaway view in which an inkjet pen is depicted in accordance with another embodiment of the invention.

FIG. 3 is another partial side elevation cutaway view of the inkjet pen depicted in FIG. 2, with the lid shown to be removably engaged with the body.

FIG. 4 is a partial side elevation cutaway view in which an inkjet pen is depicted in accordance with another embodiment of the invention.

FIG. 5 is another partial side elevation cutaway view of the inkjet pen depicted in FIG. 4, with the lid shown to be removably engaged with the body.

FIG. 6 is a partial side elevation cutaway view in which an inkjet pen is depicted in accordance with another embodiment of the invention.

FIG. 7 is another partial side elevation cutaway view of the inkjet pen depicted in FIG. 6, with the lid shown to be removably engaged with the body.

FIG. 8 is a partial side elevation cutaway view in which an inkjet pen is depicted in accordance with another embodiment of the invention.

FIG. 9 is another partial side elevation cutaway view of the inkjet pen depicted in FIG. 8, with the lid shown to be removably engaged with the body.

FIG. 10 is a partial side elevation cutaway view in which an inkjet pen is depicted in accordance with another embodiment of the invention.

### DETAILED DESCRIPTION OF THE INVENTION

Various embodiments of the present invention generally include an inkjet pen having a removable lid. An inkjet pen in accordance with one or more of the various embodiments in accordance with the present invention can include a body and a print head operatively supported on the body. A removable lid is also included and is configured to removably engage the body in one of a number of various manners in accordance with respective embodiments of the present invention so that the body together with the lid substantially encloses an ink reservoir. Liquid ink stored within the reservoir can be fed to the print head.

In accordance with yet another embodiment of the invention, a method of enclosing an inkjet pen ink reservoir includes providing a body that partially defines an ink reservoir and that has a substantially open side. The method further includes providing a lid that is configured to sealingly and removably engage the open side. The lid is placed in removable retainment with respect to the body, thereby closing the open side and substantially sealing the ink reservoir.

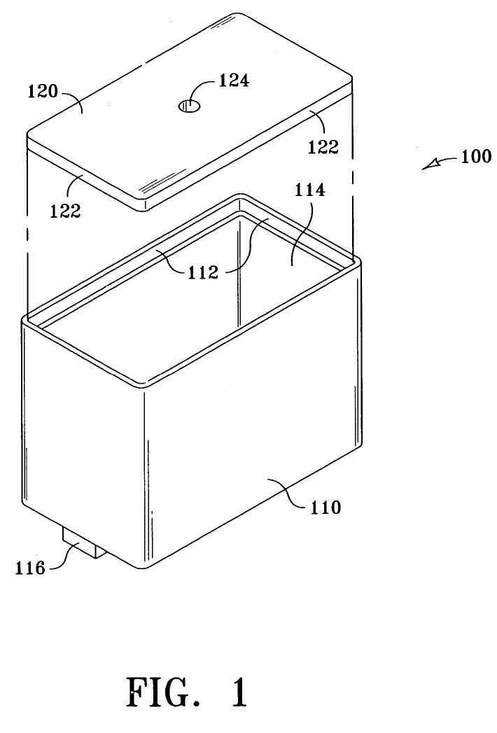

With reference to FIG. 1, an isometric view is shown in which an inkjet pen 100 is depicted in accordance with one embodiment of the present invention. The inkjet pen 100 includes a body 110. The body 110 is shaped to contain a quantity of liquid ink (not shown). That is, the body 110 defines a substantially enclosed reservoir 114 that is configured to contain the quantity of ink therein. A print head 116 can also be included and can be operatively supported by the body 110 as shown. As is discussed above with respect to the prior art, print heads such as the print head 116 are known in the art and are employed to draw liquid ink from the reservoir 114 and to selectively project droplets of ink in a predetermined pattern onto an image carrier such as a sheet of paper media (not shown) or the like.

The inkjet pen 100 also includes a removable lid 120. That is, the lid 120 is configured to be removably fitted to the body 110. Furthermore, the lid 120 is configured to removably engage the body 110, whereby the body together with the lid, when engaged therewith, act to substantially enclose the reservoir 114 for containment of liquid ink therein. The lid 120 is described as “removable” because the lid can be engaged with the body 110 for containment of ink within the reservoir 114, wherein the lid can subsequently be removed from the body, or disengaged therefrom, with relative ease, and without significant damage to the lid or to the body.

In other words, the lid 120 is not permanently attached to the body 110 when engaged therewith for containment of liquid ink within the reservoir 114. That is, the lid 120 is not attached to the body 110 by permanent or semi-permanent attachment means. For example, the lid 120 is not attached to the body 110 by using such means as heating, gluing, or by use of ultrasonic energy.

To the contrary, the lid 120 is attached to the body by way of such temporary retainment means as are explained in greater detail below. Furthermore, the “removable” nature of the lid 120 entails the configuration thereof so as to withstand multiple removals and reinstallations of the lid with respect to the body 110. That is, the lid 120 can be configured to be installed and removed numerous times with respect to the body 110.

With continued reference to FIG. 1, it is seen that the lid 120 has defined thereon a body-engaging feature 122. The term “body-engaging feature” as used herein is defined as an element or other such feature that is defined on, or otherwise connected to, the lid and which is configured to facilitate the removable retention of the lid onto the body of the inkjet pen in accordance with any of the various embodiments of the present invention.

The body-engaging feature 122 can be substantially perimetrical with respect to the lid 120, in that the body-engaging feature can be defined substantially about the perimeter of the lid. However, it is understood that the body-engaging feature 122 can alternatively be discontinuous. That is, rather than being substantially perimetrical, the body-engaging feature 122 can be located at intervals, or at defined locations with respect to the lid 120.

Likewise, the body 110 has defined thereon a lid-engaging feature 112. The term “lid-engaging feature” as used herein is defined as an element or other such feature that is defined on, or otherwise connected to, the body and which is configured to facilitate the removable retention of the lid onto the body of the inkjet pen in accordance with any of the various embodiments of the present invention.

The lid-engaging feature 112 can be in the form of a substantially planar, perimetrical, outwardly facing surface as is also shown. That is, the lid-retaining feature 112 can be perimetrical in that it can be defined substantially about the perimeter of the body 110. Also, as in the case of the body-engaging feature 122 described above, the lid-engaging feature 112 need not be continuous or perimetrical with respect to the body 110.

The respective lid-engaging feature 112 and body-engaging feature 122 defined on the body 110 and lid 120 of a given inkjet pen such as the inkjet pen 100 in accordance with the present invention, are configured to releasably engage one another in facilitation of the removable nature of the lid with respect to the body. That is, the lid-engaging feature 112 and the body-engaging feature 122 can be configured to function in conjunction with one another in facilitation of the retainment of the lid 120 to the body 110.

Still referring to FIG. 1, the body 110 and the lid 120 are configured in such respective manners, wherein the lid-engaging feature 112 and the body-engaging feature 122 retainingly engage one another when the lid is fitted to the body. That is, the lid-engaging feature 112 and the body-engaging feature 122 are each configured to engage one another so as to facilitate the retention of the lid 120 in its fitted position with respect to the body 110. The lid-engaging feature 112, as well as the body-engaging feature 122, can each have one of several other possible specific configurations, some of which are described further below and shown in the accompanying figures.

As is further seen in FIG. 1, the lid 120 can define therethrough a vent aperture 124. The vent aperture 124 is an opening that passes through the lid 120. The vent aperture 124 serves to allow vent gas, such as atmospheric air, to enter the reservoir 114 to displace depleted volumes of liquid ink as is discussed above with respect to the prior art. Inasmuch as leakage of liquid ink from the reservoir 114 is generally undesirable, the lid 120 is preferably configured to sealingly engage the body 110. That is, lid-engaging portion 112 and the body-engaging portion 122 each can be configured to engage one another in a manner whereby seepage of liquid ink between the lid 120 and the body 110 is substantially prevented.

The lid 120 can be fabricated from a material that is resiliently deformable. For example, the lid 120 can be fabricated from a material comprising an elastomer such as polyurethane, or rubber, or the like. In this manner, the lid 120 can be slightly compressed when fitted to the body 110, thus providing a substantially leak-proof seal between the lid and the body when the lid is fitted thereto. As can also be appreciated, the fabrication of the lid 120 from a resiliently deformable material can also serve to facilitate the removable nature of the lid.

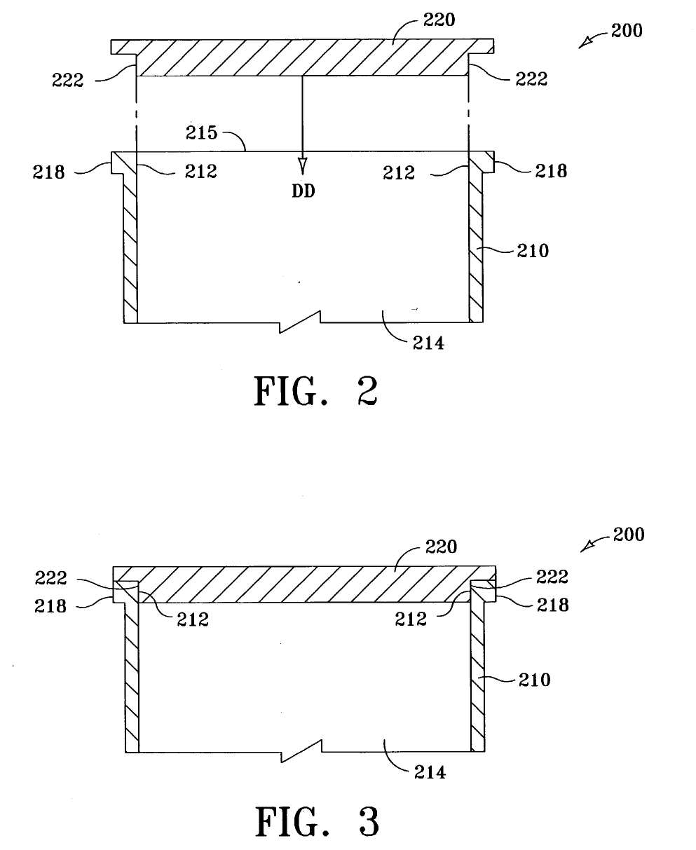

Moving now to FIG. 2, a partial side elevation sectional view is shown in which an inkjet pen 200 is depicted in accordance with another embodiment of the present invention. The inkjet pen 200 includes a body 210 that is generally similar to the body 110 of the inkjet pen 100 that is described above except as noted below. The body 210 defines a reservoir 214 that is similar to the reservoir 114 that is also described above. The inkjet pen 200 can also include a print head which is not shown, but which is similar to the print head 116 shown in FIG. 1 and described above.

Still referring to FIG. 2, the inkjet pen 200 includes a removable lid 220 that can be removably fitted to the body 210 in the manner of the lid 120 that is described above with respect to the inkjet pen 100. The body 210 of the inkjet pen 200 can have defined thereon a lid-engaging feature in the form of a body surface 212. Likewise, the lid 220 of the inkjet pen 200 can have defined thereon a body-engaging feature in the form of a lid surface 222. The lid surface 222 can be substantially perimetrical with respect to the lid 220, and the body surface 212 can be substantially perimetrical with regard to the body 210. Furthermore, the lid surface 222 and the body surface 212 both can be substantially planar and flat as shown.

As is further shown in FIG. 2, the body 210 has a substantially open side 215. The lid 220 is configured to be removably fitted with the body 210, wherein when so fitted, the open side 215 is closed off by the lid, thereby substantially enclosing the reservoir 214. That is, the lid 220 is configured to substantially fit into the open side 215, whereby the reservoir 214 is substantially completely surrounded by the body 210 together with the lid. As is also seen, the body surface 212 can be substantially perimetrical with respect to the open side 215. That is, the body surface 212 can substantially circumscribe, or delimit, the open side 215.

Further reference to FIG. 2 reveals that the lid 220 can be configured to be inserted into its fitted position with respect to the body 210 by movement along an insertion direction denoted by the arrow marked DD. The body surface 212 and the lid surface 222 both can be substantially parallel with the direction of insertion DD. In other words, the body surface 212 and/or the lid surface 220 each can define a respective prism or cylinder, wherein the body surface or the lid surface at any given point thereon, is substantially parallel to a given reference line, such as the direction of insertion DD. However, it is understood that the body surface 212 and/or the lid surface 220 can be inclined, or non-parallel, with respect to the direction of insertion.

Moving now to FIG. 3, another side elevation sectional view is shown in which the inkjet pen 200 is depicted. However, as shown in FIG. 3, the lid 220 is shown to be removably fitted to the body 210 in retaining engagement therewith. The lid 220 can be removably press-fit onto the body 210, as shown. That is, the term “press-fit” as used herein indicates a general dimensional interference fit between the body 210 and the lid 220, wherein the body surface 212 is forcibly engaged with the lid surface 222.

When attaining such a press-fit of the lid 220 with the body 210, both can be made to experience a slight dimensional compression or expansion resulting in corresponding internal compressive or tensile stresses. That is, in the specific example illustrated in FIGS. 2 and 3, the press-fit of the lid 220 onto the body 210 can result in a slight compression of the lid and a slight expansion of the body. This can result in a relatively high degree of static friction between the body surface 212 and the lid surface 222, which in turn, can serve to retain the lid 220 onto the body 210.

In the specific illustrative example depicted in FIGS. 2 and 3, the press-fit of the lid 220 with the body 210 can be achieved by making the lid slightly larger than the space provided by the body into which the lid is configured to be fitted. As mentioned above, such a press-fit of the lid 220 with the body 210 can result in a static friction therebetween that is sufficient to retain the lid on the body. As is further seen from a study of FIG. 3, a rim 218 can be defined on the body 210 proximate the open side 215 (shown in FIG. 2). The rim 218 can serve to strengthen the body 210 so as to resist permanent deformation thereof resulting from the interference fit of the lid 220 with the body.

As can be appreciated, the press-fit of the lid 220 with the body 210 can allow the lid 220 to be removed from the body 210 when a sufficient removal force is applied thereto. Thus, the respective dimensions of the lid 220 and of the body 210 which are substantially critical to achieving the desired press-fit, can be maintained in a manner wherein the lid can be inserted into its fitted position with respect to the body without damage to either the lid or the body. Furthermore, those dimensions can be maintained in a manner wherein the lid 220 is retained to the body 210 under normal operating conditions of the pen 200, but yet also wherein the lid can be removed from the body without substantial damage to either the body or the lid.

Also, it is understood that when employing the “press-fit” manner of retaining the lid 220 to the body 210 as is described above, the body and lid are both preferably fabricated from a substantially rigid material. However, it is further understood that a semi-rigid material, such as an elastomer or the like, can be employed in fabrication of the lid 220 and/or body 210 in the alternative.

Moreover, it is understood that in the illustrative example set forth in FIGS. 2 and 3, and as discussed above, the lid 220 can be configured generally in the manner of a “plug.” That is, in the general manner of a pipe plug, for example, the lid 220 can be configured to fit generally internally with respect to the body 210. In other words, the lid surface 222 can be configured to be generally facing outward while the body surface 212 is generally facing inward. However, it is understood that the lid 220 can alternatively be configured generally in the manner of a cap with substantially equal effect. That is, the lid 220 can alternatively be configured to fit over the body 210 as in the general manner of a pipe cap, for example, in which case the lid surface 222 would generally be facing inward, while the body surface 212 would generally be facing outward.

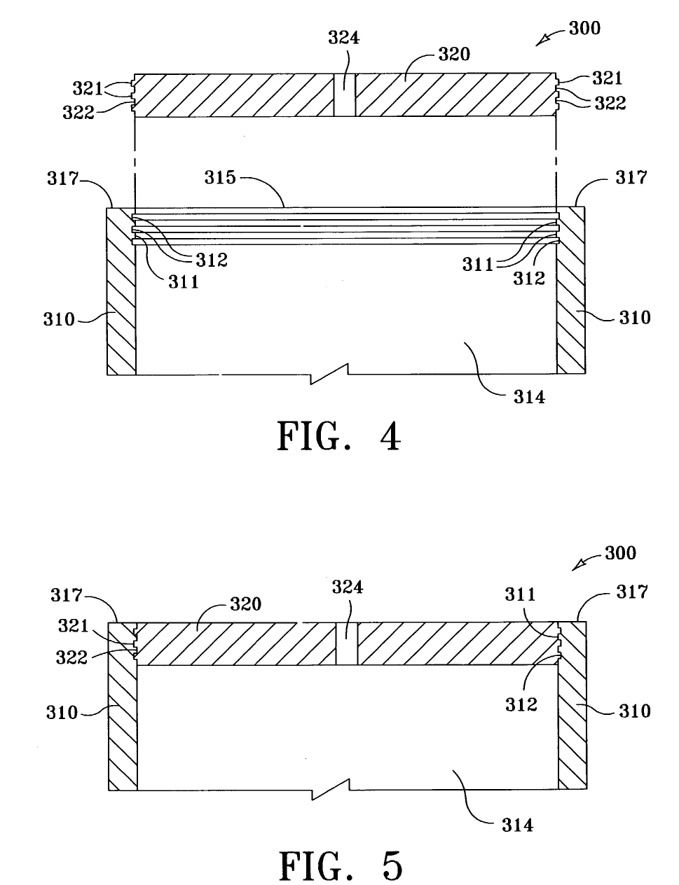

Turning now to FIG. 4, a partial side elevation sectional view is shown in which an inkjet pen 300 is depicted in accordance with another embodiment of the present invention. As is the case with regard to the inkjet pen 200 which is described above, the inkjet pen 300 includes a body 310 that partially encloses an ink reservoir 314. The body 310 has a substantially open side 315. More specifically, the body 310 can have an edge 317 defined thereon, wherein the edge substantially defines, or bounds, the open side 315. The inkjet pen 300 can include a print head (not shown) such as the print head 116 which is shown in FIG. 1 and which is described above with respect thereto.

Still referring to FIG. 4, the inkjet pen 300 can also include a lid 320 that is configured to removably engage the open side 315. That is, the lid 320 is configured to be retainingly engaged by the body 310 so that the lid together with the body substantially encloses the ink reservoir 314. The lid 320 and the body 310 can be configured in respective manners, wherein the lid is retained to the body in a fitted position with respect thereto such that leakage of ink from the reservoir 314 is substantially prevented. As is further shown in FIG. 3, a vent aperture 324 can be defined through the lid 320. The vent aperture 324 can have a plug or the like (not shown) fitted therein to prevent leakage of ink while still providing for venting of the ink reservoir 314. Such vent aperture plugging means are known in the art.

Still referring to FIG. 4, the lid 320 can have defined thereon a body-engaging portion that can be substantially in the form of a ridge 321. That is, the body-engaging portion of the lid 320 can include at least one ridge 321 that can be defined on the lid. The term “ridge” as used herein is intended to include any elongated ridge-like protrusion. Thus, a ridge, for the purposes of this discussion, can include ridges of any size including those formed by scoring, or by knurling, or by other such imprinting means, as well as those ridges formed by molding or machining or the like.

As is seen, the body-engaging portion of the lid 320 can include a plurality of ridges 321, wherein each of the plurality of ridges is preferably substantially parallel with each of the other ridges. Each ridge 321 can also be perimetrical relative to the lid 320. That is, each of the ridges 321 can be defined substantially completely about the perimeter of the lid 320, wherein each ridge substantially circumscribes the lid. However, it is understood that the ridge 321 need not be perimetrical, and alternatively, can be intermittent or discontinuous. Moreover, the ridge 321 can have any cross-sectional profile. That is, by way of example only, the ridge 321 can have a rounded profile, or alternatively, a squared-off profile.

As is further seen from a study of FIG. 4, the body-engaging feature of the lid 320 can include at least one groove 322 that can be defined on the lid. The term “groove” as used herein is intended to include any elongated impression, trough, or the like of any relative size. The groove 322 can be made by any of a number of means such as by scoring, scratching, knurling, pressing, machining, molding, or the like.

A plurality of grooves 322 can be defined on the lid 320, wherein each of the plurality of grooves can be substantially parallel with each of the other grooves. Each of the grooves 322 can also be substantially perimetrical relative to the lid 320, wherein each groove is defined substantially completely about the perimeter of the lid. However, it is understood that the groove 322 need not be perimetrical, and alternatively, can be intermittent or discontinuous. Moreover, the groove 322 can have any cross-sectional profile. That is, by way of example only, the groove 322 can have a rounded profile, or alternatively, a squared-off profile.

The body-engaging feature of the lid 320 includes a plurality of ridges 321 as well as a plurality of grooves 322 as shown. In such a case, the ridges 321 and grooves 322 can be arranged on the lid 320 in a manner wherein each pair of ridges is separated by a groove, and wherein each pair of grooves is separated by a ridge. That is, in the case wherein the body-engaging feature of the lid 320 includes a plurality of ridges 321 and a plurality of grooves 322, the ridges and grooves can be arranged in an alternating manner. Also, in such a case wherein the body-engaging feature includes a plurality of ridges 321 and a plurality of grooves 322, each of the plurality of ridges and each of the plurality of grooves can be substantially parallel to each of the other ridges and grooves.

As is further seen from a study of FIG. 4, the lid-engaging feature of the body 310 can also include at least one ridge 311 that can be defined thereon. The lid-engaging feature of the body 310 can additionally, or alternatively, include at least one groove 312 that can be defined on the body.

That is, as in the case of the body-engaging feature of the lid 320 as is described above, the lid-engaging feature of the body 310 can include a ridge 311 and/or a groove 312. The ridge 311 and/or the groove 312 can be substantially parallel with the edge 317. The lid-engaging feature of the body 310 includes at least one ridge 311 as well as at least one groove 312, and can also include a plurality of ridges and a plurality of grooves.

In such a case wherein the lid-engaging feature of the body 310 includes a plurality of ridges 311 and a plurality of grooves 312, each of the plurality of ridges and the plurality of grooves can be arranged so as to be substantially parallel with each of the other ridges and grooves. Furthermore, the plurality of ridges 311 and the plurality of grooves 312 can be arranged in an alternating manner, wherein each ridge 311 lies between two adjacent grooves 312, and vice versa. As is seen, the ridges 321 and grooves 322 of the lid 320 can be substantially outwardly facing, while the ridges 311 and grooves of the body 310 can be substantially inwardly facing.

That is, as is depicted by way of the illustrative example shown in FIGS. 4 and 5, the lid 320 can be substantially in the form of a plug as is explained above with respect to the lid 220 and body 210 of the inkjet pen 200. However, it is understood that in the alternative, the lid 320 of the inkjet pen 300 can be configured generally in the manner of a cap in which case the ridges 321 and grooves 322 of the lid 320 would face substantially inward, while the ridges 311 and grooves 312 of the body 310 would face substantially outwardly.

In any case, each ridge 311 defined on the body 310 can be associated with a corresponding groove 322 defined on the lid 320, and vice versa. Likewise, each groove 312 defined on the body 310 can be associated with a corresponding ridge 321 defined on the lid 320, and vice versa. In this manner, each ridge 311 defined on the body 310 can meshingly engage with the corresponding groove 322 defined on the lid 320 when the lid is retainingly fitted with the body. Similarly, each groove 312 defined on the body 310 can meshingly engage with the corresponding ridge 321 defined on the lid 320 when the lid is retainingly fitted with the body.

The lid 320 and/or the body 310 can be fabricated from a semi-rigid material such as an elastomer or the like. In such a case, the lid 320 and/or the body 310 which is fabricated from the semi-rigid material can be made slightly over-sized so that the part fabricated from the semi-rigid material can be slightly compressed, or stretched, respectively, when the lid is fitted with the body. In this manner, the fitment of the lid 320 with the body 310 can be made more leak-proof. Also, this manner of fitment of the lid 320 with the body 310 can facilitate more positive retention of the lid to the body.

Turning now to FIG. 5, a partial side elevation sectional view is shown in which the inkjet pen 300 is shown with the lid 320 retainingly engaged with the body 310. A study of FIG. 5 reveals the manner in which each of the ridges 311 defined on the body 310 can meshingly engage with a corresponding groove 322 defined on the lid 320. Also revealed in the manner in which each of the ridges 321 defined on the lid 320 can meshingly engage with a corresponding groove 312 defined on the body 310. In this manner, the lid 320 can be removably and sealingly engaged with the body 310.

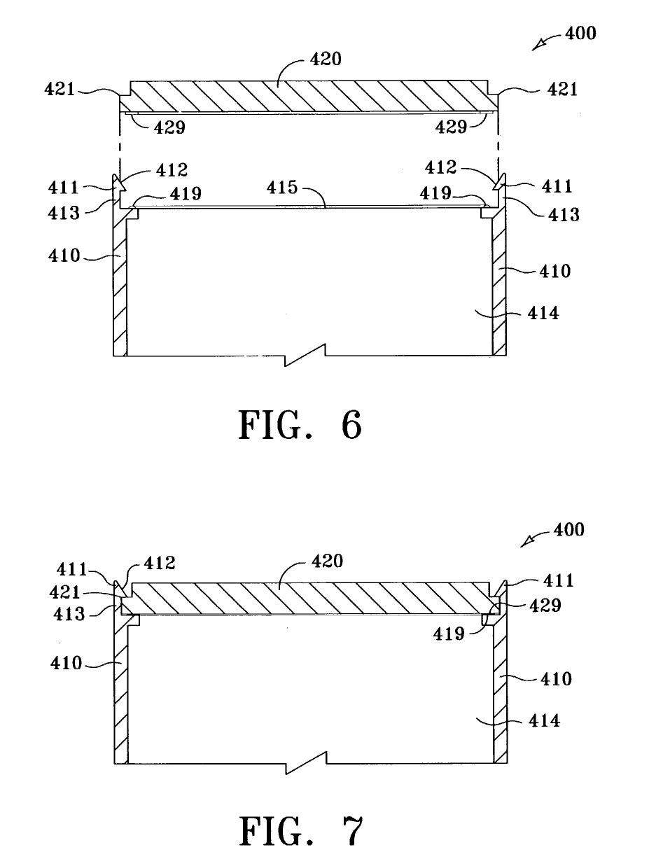

Now turning now to FIG. 6, a partial side elevation sectional view is shown in which an inkjet pen 400 is shown in accordance with a further embodiment of the present invention. As is seen, the inkjet pen 400 includes a body 410 that at least partially defines an ink reservoir 414. The body 410 has defined thereon a lid-engaging feature that is in the form of a barb 411. The term “barb” as used herein is defined to mean a catch device that is defined on a first object and which is employed to releasably retain a second object against the first object.

The barb 411 can be supported by a deflectable or deformable extension 413 as is explained in greater detail below. The barb 411 can be substantially perimetrical with respect to the body 410 in that the barb can be defined substantially about the perimeter of the body. However, it is understood that the barb 411 can be located in any position with respect to the body 410.

Furthermore, the barb 411 can be non-perimetrical in that it can be located at intervals or specific points about the periphery of the body 410. By way of example only, the body 410 can have two elongated barbs 411 defined thereon, wherein each of the two elongated barbs is located on respective opposing sides of the body as is depicted in FIGS. 6 and 7.

Still referring to FIG. 6, the inkjet pen 400 can include a lid 420 that is configured to be retainingly fitted to the body 410, wherein the lid together with the body substantially encloses the ink reservoir 414. That is, the body 410 can have a substantially open side 415 onto which the lid 420 is configured to be releasably retained, thereby substantially enclosing the ink reservoir 414. The body 410 can also include a sealing member 419 supported thereby that can be in the form of a substantially raised ridge as shown. The sealing member 419 is preferably perimetrical with respect to the open side 415.

The lid 420 can have a body-engaging feature that can be in the form of a lip 421. The lip 421 is configured to engage a corresponding barb 411 that is supported on the body 410, thereby providing releasable retainment of the lid 420 to the body. The lid 420 can have a sealing member 429 supported thereby that can be perimetrical with respect to the lid. The sealing member 429 can be in the form of a compressible gasket or the like. The sealing member 429 can be further configured to function in conjunction with the sealing member 419 that is supported by the body 410 to thereby facilitate substantial sealing of the ink reservoir 414 when the lid is retainingly engaged with the body.

Each of the barbs 411 can have a ramp face 412 defined thereon. The ramp face 412 can be inclined or oblique with respect to the path which the lid 420 follows when being installed on the body 410. As is mentioned above, each of the barbs 411 can also be supported on a resiliently deflectable, or flexible, extension 413. The extension 413 together with the ramp face 412 function to facilitate ease of installation of the lid 420 to the body 410.

For example, during installation, the lid 420 can be moved toward the body 410 as indicated in FIG. 6. As the lid 420 approaches the body 410, the lower edges of the lid can contact the ramp face 412 of each respective barb 411 whereupon further movement of the lid toward the body causes each respective extension to flex, or deflect outwardly, as is shown by way of the illustrative example provided in FIG. 6.

Further movement of the lid 420 toward the body 410 can result in full contact of the lid with the body, whereupon the lip 421 can move slightly past the barb while the sealing members 419 and 429 are slightly compressed. This can allow the extension 413 to “spring back,” or move to its non-deflected position, whereby the barb 411 is moved over the top of the lip 421. In this manner, the lid 420 can be placed into retaining engagement with the body 410.

Moving now to FIG. 7, a partial side elevation sectional view is shown in which the inkjet pen 400 is shown with the lid 420 retainingly engaged with the body 410. It is thus seen from a study of FIG. 7 that the barb 411 can releasably engage a corresponding lip 421 to thereby retain the lid 420 to the body 410. That is, the engagement of the barb 411 and the lip 421 can cause the lid 420 to be releasably retained against the open side 415 of the body 410, thereby substantially enclosing the ink reservoir 414. It is also seen that when the lid 420 is retainingly fitted to the body 410 as shown in FIG. 7, then the sealing members 419, 429 can be sealingly engaged with one another, thereby substantially preventing leakage of ink from the reservoir 414.

With reference now to FIG. 8, another partial side elevation sectional view is shown in which an inkjet pen 500 is depicted in accordance with yet another embodiment of the present invention. It is seen that the inkjet pen 500 can be substantially similar to the inkjet pen 400 discussed above with the exception that the relative positions of the barb and lip are reversed. That is, with respect to the inkjet pen 500, the lip 511 can be defined on the body 510, while the barb 521 can be defined on the lid 520. Furthermore, the barb 521 can be configured to function in a manner substantially similar to that of the barb 411 which is explained above with respect to FIGS. 6 and 7, and therefore, it is understood that no further explanation of the function of the barb 521 is needed.

Thus, the body 510 has defined thereon a lid-engaging feature that can be in the form of a lip 511. Correspondingly, the lid 520 has defined thereon a body-engaging feature that can be in the form of a barb 521. The barb 521 is configured to retainingly engage the lip 511 when the lid 520 is retainingly fitted with the body. That is, when the lid 510 is fitted to the open side 515 of the body 510 to thereby substantially enclose the reservoir 514, the barb 521 and the lip 511 can substantially engage one another so as to releasably retain the lid to the body.

As is further shown in FIG. 8, the body 510 can have a sealing member 519 supported thereby, wherein the sealing member can be in the form of a raised ridge or the like. Similarly, the lid 520 can have a sealing member supported thereby, wherein the sealing member can be in the form of a gasket or the like. As in the case of the inkjet pen 400 discussed above, the sealing members 419, 429 can be configured to function in conjunction with one another to substantially prevent leakage of ink from the reservoir 514 when the lid 520 is retainingly fitted to the open side 515 of the body 510.

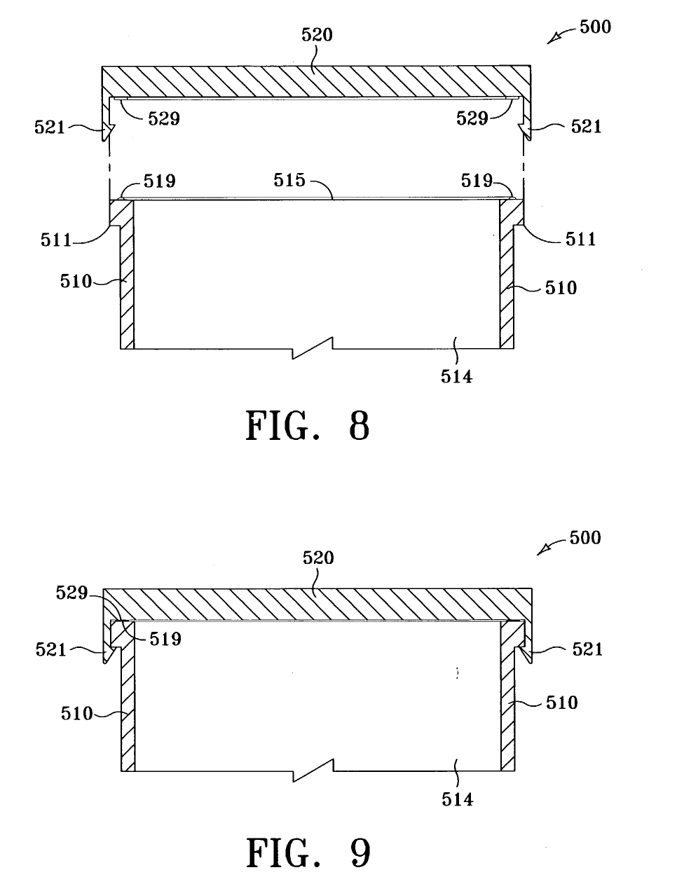

Moving to FIG. 9, another partial side elevation sectional view is shown in which the inkjet pen 500 is depicted with the lid 520 retainingly fitted to the body 510. As is seen, the barb 521 can be retainingly engaged with the lip 511 to facilitate retention of the lid 520 to the body 510. As is also seen, the sealing members 519, 529 can be sealingly engaged with one another as the result of the lid 520 being retainingly fitted with the body 510, thereby substantially preventing leakage of ink from the reservoir 514.

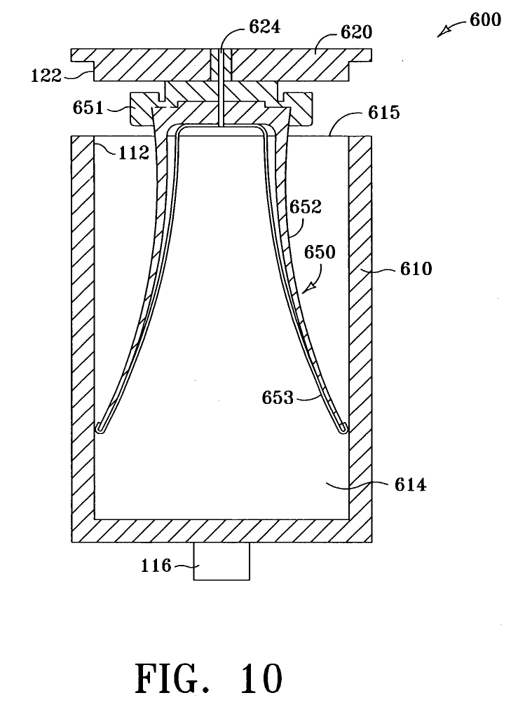

Moving now to FIG. 10, a side elevation sectional view is shown in which an inkjet pen 600 is depicted in accordance with a further embodiment of the invention. The inkjet pen 600 includes a body 610 that substantially defines an ink reservoir 614. The inkjet pen 600 also includes a removable lid 620 that is configured to be removably fitted with the body 610 in sealing retention thereof, whereby the ink reservoir 614 is substantially enclosed. More specifically, the body 610 can have a substantially open side 615 to which the lid 620 is configured to be retainingly fitted. The body 610 can have a print head 116 operatively supported thereby.

Furthermore, the body 610 can have defined thereon a lid-engaging portion that can have any of a number of possible specific configurations, including one of those discussed above with respect to the inkjet pen bodies 210, 310, 410, and 510, and which are shown in the respective accompanying figures.

Similarly, the lid 620 can have defined thereon a body-engaging portion that can have any of a number of possible specific configurations, including one of those discussed above with respect to the inkjet pens 220, 320, 420, and 520 and which are also shown in the respective accompanying figures.

As is further shown in FIG. 10, the inkjet pen 600 can include a bladder assembly 650. The bladder assembly 650 can be supported by the lid 620 as shown. The bladder assembly 650 can be configured to contain liquid ink (not shown). Alternatively, the bladder assembly 650 can be configured to contain vent air. That is, the term “bladder assembly” as used herein is intended to encompass any bladder assembly regardless of the specific configuration, function, or purpose thereof.

The bladder assembly 650 can include a hanger assembly 651 that can be supported by the lid 620. In turn, the hanger assembly 651 can support a spring assembly 652 and a bladder 653. Such bladder assemblies are generally well known in the art. The bladder assembly 650 is configured to fit within the reservoir 614 when the lid 620 is fully engaged, and retainingly fitted, with the body 610.

It is understood that the bladder assembly 650 can, in the alternative, be supported by the body 610 rather than by the lid 620 as is depicted in FIG. 10 by way of illustrative example only. The inkjet pen 600 can also include additional, or alternative, components such as a filter, and/or a section of capillary reticulate material (e.g. foam) or the like.

Initially, the body 610 and the lid 620 can be assembled such that the lid is removably fitted in retaining engagement with the body in any of a number of manners such as is described above by way of example only for any of the inkjet pens 200, 300, 400, 500. A supply of ink (not shown) can also be initially contained within the reservoir 614, either within the bladder 653 or outside of the bladder depending on the specific configuration of the bladder assembly.

If a given component of the inkjet pen 600 should fail, thus rendering the inkjet pen inoperable for example, then the lid 620 can be removed to allow access to the internal components such as the bladder assembly 650 or the filter (not shown) or the capillary reticulate material if so equipped. Regardless of which component fails, if such a component failure occurs, the removable nature of the lid 620 facilitates the recovery of the salvageable and/or serviceable components.

For example, if the body 610 should experience a failure such as a crack or the like, then the lid 620 can be relatively easily removed from the body along with the bladder assembly 650 and/or other serviceable components. The lid 610 and bladder assembly 650 and/or other serviceable components can then be reinstalled into a serviceable body 610. The relative ease with which the removable lid 620 can be removed from the failed body 610 and/or reinstalled onto a serviceable body can result in reduced effort expended in order to salvage and/or recover serviceable components from the failed inkjet pen.

In accordance with yet another embodiment of the invention, a method of enclosing an inkjet pen ink reservoir includes providing a body that partially defines an ink reservoir, wherein the body has a substantially open side. For example, the body can be a body such as any of the bodies 110, 210, 310, 410, 510 and 610 which are described above and which are depicted in the accompanying figures.

The method also includes providing a lid that is configured to sealingly and removably engage the open side. For example, the lid can be a lid such as any of the lids 120, 220, 320, 420, 520, and 620 which are described above and which are depicted in the accompanying figures. The method can also include placing the lid in removable retainment with respect to the body. That is, the method can include closing the open side and substantially sealing the ink reservoir by removably fitting the lid to the body.

The method can further include providing an interference fit between the lid and the body. Such an interference fit of the lid with the body can facilitate retainment of the lid with respect to the body. Such an interference fit of the lid with the body is described in greater detail above with respect to the inkjet pen 200 which is depicted in FIGS. 2 and 3.

While the above invention has been described in language more or less specific as to structural and methodical features, it is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

What is claimed is:

1. An inkjet pen, comprising:
a body;
a print head operatively supported by the body; and,
a removable lid configured to removably engage the body, whereby the body together with the lid engaged therewith substantially encloses an ink reservoir, and wherein the lid is fabricated from a material that is resiliently deformable.

2. The inkjet pen of claim 1, and wherein a vent aperture is defined through the lid.

3. The inkjet pen of claim 1, and wherein the lid is fabricated from a material comprising an elastomer.

4. The inkjet pen of claim 1, and further comprising a body-engaging feature defined on the lid, wherein the body-engaging feature is configured to retainingly engage the body.

5. The inkjet pen of claim 4, and wherein the body-engaging feature comprises a groove defined on the lid.

6. The inkjet pen of claim 4, and wherein the body-engaging feature comprises a ridge defined on the lid.

7. The inkjet pen of claim 1, and further comprising a lid-engaging feature defined on the body, and wherein the lid-engaging feature portion is configured to retainingly engage the lid.

8. The inkjet pen of claim 7, and wherein the lid-engaging feature comprises a groove defined on the body.

9. The inkjet pen of claim 7, and wherein the lid-engaging feature comprises a ridge defined on the body.

10. The inkjet pen of claim 1, and further comprising a bladder assembly supported by the lid.

11. The inkjet pen of claim 1, and wherein:
the body defines a substantially open side; and,
the lid is removably press-fit to the body, thereby closing the open side.

12. The inkjet pen of claim 11, and further comprising:
a substantially planar body surface defined on the body, wherein the body surface is substantially perimetrical with respect to the open side; and,
a substantially planar lid surface defined on the lid, wherein the lid surface is substantially perimetrical with respect to the lid, and wherein the lid surface and the body surface are configured to be forcibly engaged with one another in substantially parallel, juxtaposed registration therewith, thereby facilitating removable retention of the lid to the body.

13. The inkjet pen of claim 1, and wherein the lid is not attached to the body by heat, by gluing, or by using ultrasonic energy.

14. An inkjet pen, comprising:
a body partially enclosing an ink reservoir and having a substantially open side, wherein:
an edge is defined on the body;
the edge substantially defines the open side; and,
a lid-engaging feature is defined on the body; and,
a lid configured to sealingly and removably engage the open side, thereby substantially enclosing the ink reservoir, and wherein a body-engaging feature is defined on the lid and is configured to matingly engage the lid-engaging feature, thereby facilitating sealable retention of the lid on the body.

15. The inkjet pen of claim 13, and wherein:
the lid-engaging feature comprises a substantially inwardly facing perimetrical ridge that is defined on the body and that is substantially parallel to the edge; and
the body-engaging feature comprises a substantially outwardly facing perimetrical groove that is defined on the lid and that is configured to matingly engage the ridge.

16. The inkjet pen of claim 13, and wherein:
the lid-engaging feature comprises a substantially inwardly facing perimetrical groove that is defined on the body and that is substantially parallel to the edge; and
the body-engaging feature comprises a substantially outwardly facing perimetrical ridge that is defined on the lid and that is configured to matingly engage the groove.

17. The inkjet pen of claim 14, and wherein:
the lid-engaging feature comprises a lip;
the body-engaging feature comprises a barb; and,
the barb is configured to retainingly engage the lip, thereby functioning to releasably fasten the lid to the body.

18. The inkjet pen of claim 14, and wherein:
the body-engaging feature comprises a lip;
the lid-engaging feature comprises a barb; and,
the barb is configured to retainingly engage the lip, thereby functioning to releasably fasten the lid to the body.

19. The inkjet pen of claim 17, and wherein:
the body-engaging feature comprises a retaining extension protruding from the lid; and,
the barb is supported on the retaining extension.

20. The inkjet pen of claim 18, and wherein:
the lid-engaging feature comprises a retaining extension protruding from the body; and,
the barb is supported on the retaining extension.

21. A method of enclosing an inkjet pen ink reservoir, comprising:
providing a body which partially defines the ink reservoir and which has a substantially open side;
providing a lid which is configured to sealingly and removably engage the open side;
placing the lid in removable retainment with respect to the body, thereby closing the open side and substantially sealing the ink reservoir, and wherein an interference fit is provided between the lid and the body, thereby facilitating retainment of the lid with respect to the body.

22. An inkjet pen, comprising:
a body that partially encloses an ink reservoir, and that defines a substantially open side;
a lid that is configured to be removably retained on the body, thereby substantially closing the open side and enclosing the ink reservoir; and,
a retaining means for removably retaining the lid on the body, wherein the retaining means includes a barb and a lip.

23. An inkjet pen, comprising:
a body that partially encloses an ink reservoir, and that defines a substantially open side;
a lid that is configured to be removably retained on the body, thereby substantially closing the open side and enclosing the ink reservoir;
a retaining means for removably retaining the lid on the body, wherein the retaining means includes a groove and a ridge.
